(19) United States
(12) Patent Application Publication
(10) Pub. No.: US 2024/0211918 A1
(43) Pub. Date: Jun. 27, 2024

(54) COMMODITY INFORMATION REGISTRATION APPARATUS AND COMMODITY INFORMATION REGISTRATION METHOD

(71) Applicant: Toshiba Tec Kabushiki Kaisha, Tokyo (JP)

(72) Inventors: Maki SATO, Yokohama Kanagawa (JP); Sayo SONAGA, Kawasaki Kanagawa (JP); Yumiko OKUMA, Koganei Tokyo (JP)

(21) Appl. No.: 18/471,258

(22) Filed: Sep. 20, 2023

(30) Foreign Application Priority Data
Dec. 21, 2022 (JP) 2022-204739

(51) Int. Cl. G06Q 20/20; G06K 7/14

(52) U.S. Cl. CPC G06Q 20/208; G06K 7/1413

(57) ABSTRACT

According to one embodiment, a commodity registration apparatus includes a commodity reader to obtain commodity identification information of a commodity being registered in a sales transaction and a processor. The processor registers the commodity read by the commodity reader in the sales transaction and causes a display device to display a first screen including commodity information of a registered commodity, the total number of registered commodities in the sales transaction, and the total amount due for the sales transaction. The first screen further includes a first operation element configured to cause a second screen to be displayed when selected by a user. The commodity information of the registered commodity is displayed larger than the values of the total number of registered commodities and the total amount due. The second screen provides information including a detail list of the registered commodities in the sales transaction.

### CROSS-REFERENCE TO RELATED APPLICATION

This application is based upon and claims the benefit of priority from Japanese Patent Application No. 2022-204739, filed Dec. 21, 2022, the entire contents of which are incorporated herein by reference.

### FIELD

Embodiments described herein relate generally to a commodity information registration apparatus and a commodity information registration method.

### BACKGROUND

For a face-to-face type POS, it is known that commodity information of a commodity currently being registered and a commodity list of commodities already registered so far can be switched and displayed on a display for an operator.

A display operation system of a commodity sales data processing device disclosed in the related art may be easy to use for those operators who are already familiar with the operation. However, a display operation system of a self-service POS or a cart POS operated by a customer himself or herself is required to have further improved visibility and operability so that the customer does not extra take time for the operation.

### BRIEF DESCRIPTION OF THE DRAWINGS

FIG. 1 is an external view of a self-service POS terminal according to an embodiment.

FIG. 2 is a hardware block diagram of a self-service POS terminal according to an embodiment.

FIG. 3 is a diagram showing an example of a data structure of a commodity master.

FIG. 4 is a diagram showing an example of a data structure of a commodity registration file.

FIG. 5 is a block diagram depicting a functional configuration of a self-service POS terminal according to an embodiment.

FIG. 6 is a diagram showing an example of a screen displayed on a display device of a self-service POS terminal during commodity registration.

FIG. 7 is a diagram depicting an animation display displayed on a display device of a self-service POS terminal during commodity registration.

FIG. 8 is a diagram showing an example of a registration detail screen displayed on a display device of a self-service POS terminal after a detail display button is pressed.

FIG. 9 is a diagram depicting an animation display displayed on a display device of a self-service POS terminal when the detail display button is pressed.

FIG. 10 is a flowchart of commodity registration processing performed by a self-service POS terminal according to an embodiment.

FIG. 11 is a diagram showing an example of a screen displayed on a display device of a self-service POS terminal when a bulk discount commodity is registered.

FIG. 12 is a diagram showing an example of a screen displayed on a display device of a self-service POS terminal when a plurality of bulk discount commodities are registered.

FIG. 13 is a diagram showing an example of a screen displayed on a display device of a self-service POS terminal when a bulk discount condition is satisfied.

FIG. 14 is a diagram showing an example of a registration detail screen displayed on a display device of a self-service POS terminal when a bulk discount condition is satisfied.

FIG. 15 is a flowchart of commodity registration processing for a bulk discount commodity performed by a self-service POS terminal according to an embodiment.

FIG. 16 is a diagram showing an example of a screen for selecting the type and number of bags to be used.

FIG. 17 is a diagram showing an example of a current status screen displayed when bags are insufficient during commodity registration.

FIG. 18 is a diagram showing an example of a registration detail screen displayed after a bag alert button is pressed.

FIG. 19 is a diagram showing an example of a screen displayed when the required bags are reselected.

FIG. 20 is a flowchart of bag sufficiency determination processing performed by a self-service POS terminal according to an embodiment.

FIG. 21 is a diagram showing an example of a current status screen displayed when advertisement information for a customer is present during commodity registration.

FIG. 22 is a diagram showing an example of a registration detail screen displayed when advertisement information for a customer is present during commodity registration.

FIG. 23 is a diagram showing an example of a screen displayed when advertisement information is viewed.

FIG. 24 is a diagram showing an example of a screen displayed when registration of a commodity is suspended.

FIG. 25 is a flowchart showing an example of a flow of advertisement information display processing performed by a self-service POS terminal according to an embodiment.

### DETAILED DESCRIPTION

A commodity information registration apparatus and a commodity information registration method are provided as technological solutions for addressing existing issues in the related art related to interaction with an apparatus operator during commodity registration. The apparatus and method provide smoother and more efficient interactions between the apparatus and the operator during commodity registration processes.

In general, according to one embodiment, a commodity information registration apparatus includes a commodity reader configured to obtain commodity identification information for a commodity being registered in a sales transaction and a processor. The processor is configured to register the commodity corresponding to the commodity identification information read by the commodity reader in the sales transaction and cause a display device to display a first display screen including commodity information of a registered commodity, an indicator of the total number of registered commodities in the sales transaction, and a total amount due indicator indicating the amount of money due in the sales transaction for the registered commodities. The first display screen further includes a first operation element configured to cause a second display screen to be displayed when selected by a user. The commodity information of the registered commodity is displayed larger than the indicator of the total number of registered commodities and the total amount due indicator. The second display screen provides information including a detail list of the registered commodities.

In an embodiment, a commodity information registration apparatus of the present disclosure is a self-service POS terminal 1, however, the present disclosure is not limited to a self-service POS terminal 1, and the present disclosure can also be applied to a cart POS, a smartphone POS, a face-to-face POS (clerk-operated POS), or the like. Certain non-limiting example embodiments are described below in conjunction with the drawings.

### Schematic Configuration of Self-Service POS Terminal

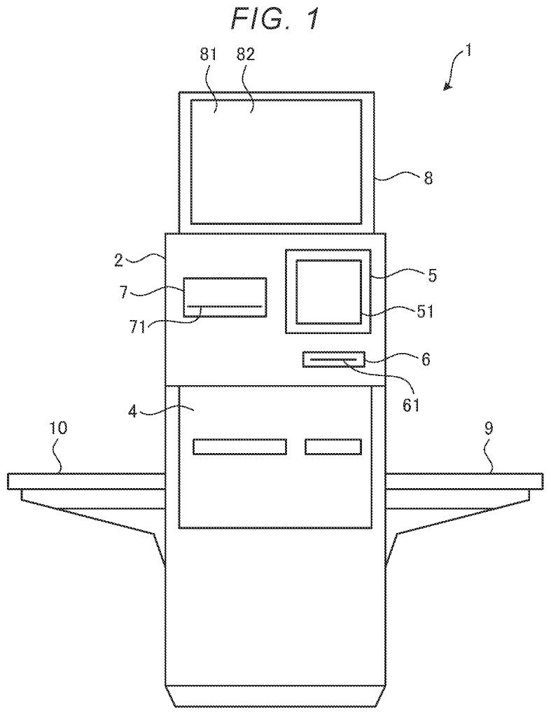

A schematic configuration of the self-service POS terminal 1 will be described with reference to FIG. 1. FIG. 1 is an external view showing an example of a self-service POS terminal according to an embodiment.

As shown in FIG. 1, the self-service POS terminal 1 includes, for example, a vertically long substantially rectangular parallelepiped housing 2. The self-service POS terminal 1 includes a deposit and withdrawal unit 4 on a lower side. The money paid by a customer is deposited into the deposit and withdrawal unit 4 and change to be paid to the customer is withdrawn from the deposit and withdrawal unit 4 under the control of a control unit 100. The self-service POS terminal 1 is an example of a commodity information registration apparatus.

A control unit 100 is housed in an upper portion of the housing 2. In addition, a code reading unit 5, a card reading unit 6, and a printing unit 7 are installed on the upper portion of the housing 2 to be operated or accessed by the customer.

The code reading unit 5 is a reading device that reads a code symbol such as a bar code or a two-dimensional code. The code reading unit 5 reads the code symbol via a reading window 51 formed in the housing 2. For example, the code reading unit 5 reads a code symbol attached to a commodity being registered or a code symbol displayed on a portable terminal of a user. The code reading unit 5 reads code information indicating store member information (e.g., a store loyalty program membership) displayed on a smartphone or the like of a customer. In the code information, identification information for uniquely specifying a customer can be registered. The code reading unit 5 may be or incorporate a type such as a handy (hand-held) scanner that is held and operated by a customer.

The card reading unit 6 is a reading device that reads information held in a card-type medium. The card reading unit 6 reads information from a card medium inserted into a card insertion slot 61. For example, the card reading unit 6 reads information related to electronic payments from a credit card or an electronic money card. The card reading unit 6 may also read identification information for uniquely specifying a customer from a membership card carried by the customer and inserted into the card insertion slot 61.

The printing unit 7 is a printing device such as a thermal printer. The printing unit 7 prints a receipt related to a commodity purchased by a customer, and outputs (dispenses) the printed receipt from a receipt dispensing port 71 formed in the housing 2.

The self-service POS terminal 1 also includes a display operation unit 8 positioned above the housing 2 in this example. The display operation unit 8 includes a display device 81 such as a liquid crystal display (LCD) and an operation unit 82 (user input unit) implemented as a touch panel or the like. The display device 81 can display various screens under the control of the control unit 100. The operation unit 82 is provided on a surface of the display device 81, and outputs information to the control unit 100 corresponding to a position on the displayed screen touched by the customer.

A basket placing table 9 is provided on one side surface or lateral side of the self-service POS terminal 1. The basket placing table 9 is a table for a basket to be placed and is used for a shopping basket or the like holding unregistered items.

[symbol] a bag receiving table 10 for receiving a commodity after the code symbol has been read by the code reading unit 5 (or otherwise registered in the sales transaction) is provided on the other side surface or lateral side of the self-service POS terminal 1.

### Hardware Configuration of Self-Service POS Terminal

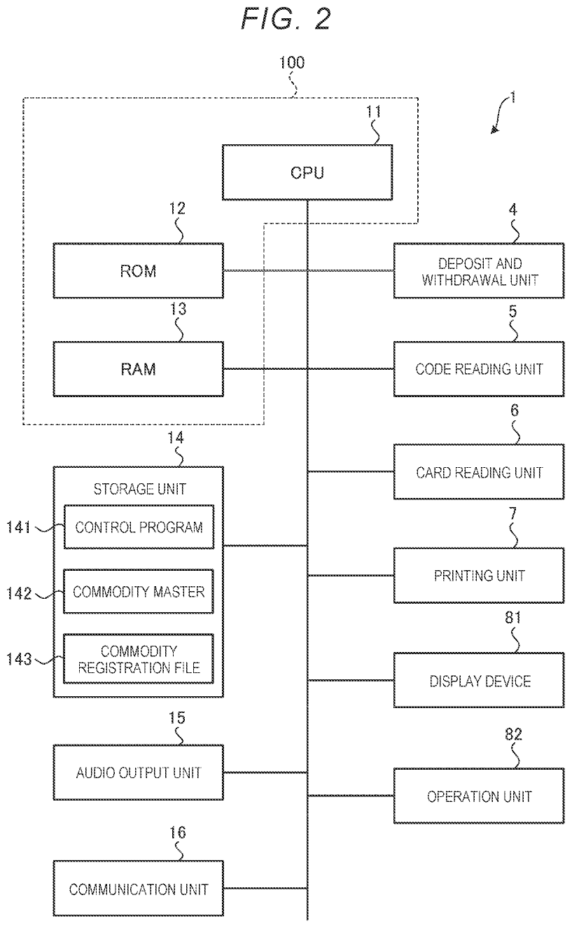

The hardware configuration of the self-service POS terminal 1 will be described with reference to FIG. 2. FIG. 2 is a block diagram showing an example of the hardware configuration of the self-service POS terminal 1.

As shown in FIG. 2, the self-service POS terminal 1 includes the deposit and withdrawal unit 4, the code reading unit 5, the card reading unit 6, the printing unit 7, the display device 81, and the operation unit 82, which are described above.

The self-service POS terminal 1 includes a central processing unit (CPU) 11, a read only memory (ROM) 12, a random access memory (RAM) 13, a storage unit 14, an audio output unit 15, and a communication unit 16. The CPU 11 is connected to the other components in the hardware configuration shown in FIG. 2 via a bus or the like.

The CPU 11 is an example of a processor and controls the various units of the self-service POS terminal 1. The ROM 12 stores various programs. The RAM 13 is a workspace for programs and various pieces of data. Here, the CPU 11, the ROM 12, and the RAM 13 constitute the control unit 100, which may be a computer.

The storage unit 14 includes a storage medium such as a hard disk drive (HDD) or a flash memory, and maintains storage contents even when the power is turned off. The storage unit 14 stores various programs that can be executed by the CPU 11 and various pieces of setting information. In this example, storage unit 14 stores a control program 141, a commodity master 142, and a commodity registration file 143.

The control program 141 is a program for providing the described functions of the self-service POS terminal 1.

The control program 141 may be provided by being incorporated in the ROM 12 in advance. The control program 141 may be provided by being recorded in a non-transitory, computer-readable recording medium such as a CD-ROM, a flexible disk (FD), a CD-R, or a digital versatile disc (DVD) in a file of an installable form or an executable form in the control unit 100. The control program 141 may be stored in a computer connected to a network such as the Internet and provided by being downloaded via the network. The control program 141 may be provided, accessed, or distributed via a network such as the Internet.

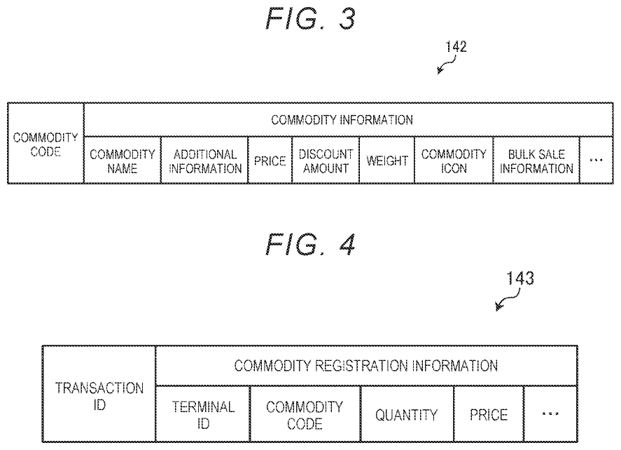

The commodity master 142 is a master file in which information about the commodities (items) sold at the store is stored. A specific structure of a commodity master 142 will be described later (see FIG. 3). Since the content of the commodity master 142 must be updated as needed (as products are added or removed, prices changed, etc.), the self-service POS terminal 1 generally acquires the latest commodity master 142 from a store server or the like via the communication unit 16.

The commodity registration file 143 is a file in which information related to the commodity code(s) read by the code reading unit, that is, information related to a commodity being purchased by a customer in a sales transaction is stored. A specific structure of a commodity registration file 143 will be described later (see FIG. 4).

The audio output unit 15 is an audio output device such as a speaker. The audio output unit 15 outputs, under the control of the control unit 100, a sound, tone, recording, or a sound effect for supporting an operation of the customer. The communication unit 16 is a communication interface that can be connected to a network such as a local area network (LAN). The communication unit 16 communicates, via a network, with an external device such as a store server provided in a store or an electronic payment server providing an electronic payment service.

### Data Structure of Various Data Stored in Self-Service POS Terminal

FIG. 3 is a diagram showing an example of a data structure of a commodity master. FIG. 4 is a diagram showing an example of a data structure of a commodity registration file.

As shown in FIG. 3, the commodity master 142 stores, in correlation with a commodity code capable of identifying a commodity, a commodity name, additional information, a price, a discount amount, a weight, a size, a commodity icon, bulk sale information, and the like (hereinafter, also collectively referred to as commodity information) of the commodity (product) specified by the commodity code.

The commodity code is commodity identification information such as a JAN code, for example. A code symbol such as a bar code or a two-dimensional code encoding a commodity code of the commodity is typically attached to each commodity sold in the store. A commodity being purchased can be identified by reading a commodity code from a code symbol attached to the commodity.

The commodity name is information indicating the name of a commodity, such as a formal name of the commodity. In addition to the formal name of the commodity, information for simply displaying the commodity name, such as an abbreviation, alternate name, and/or a nickname of the commodity may be stored.

As the additional information, any additional potentially relevant information related to the commodity can be stored. For example, when the commodity is an apparel item such as clothing, the clothing size or the like of the commodity may be stored as additional information.

The price is information indicating a unit price of a commodity (a per item price).

The weight is information indicating a weight of the commodity (nominal expected weight). The size is information indicating dimensions of a commodity in a packed state. The weight and the size values are used as information for determining whether all commodities being purchased in a transaction can be accommodated in the bag(s) registered (selected) by the customer.

The commodity icon is icon information for schematically displaying an appearance of a commodity on a display screen or the like.

The bulk sale information is information related to a potential combination of commodities that provide a further discount when commodities are purchased in bulk.

The data configuration of the commodity master 142 is not limited to the example of FIG. 3. For example, in the commodity master 142, image data or the like representing features (appearance) of a commodity may be included and stored in the commodity information. The commodity master 142 also holds commodity information even for the bags (bag types) sold in the store.

As shown in FIG. 4, the commodity registration file 143 stores a terminal ID, a commodity code, a quantity, a price, and the like in correlation with a transaction ID. The transaction ID is dispensed (generated) by the self-service POS terminal 1 when the first commodity is registered in a transaction.

The terminal ID is identification information that uniquely specifies the self-service POS terminal 1 being used for the registration of items. The terminal ID is typically a preset value set for each self-service POS terminal 1 in the store.

The commodity code is a commodity code of a commodity registered in the transaction (a registered commodity) for purchase.

The quantity is the number of registered commodities corresponding to the same commodity code.

The price is a price of the item(s) corresponding to the commodity code (in this context, the price value is the commodity unit price multiplied by the quantity of the commodity being purchased).

The data configuration of the commodity registration file 143 is not limited to the example of FIG. 4. For example, the commodity registration file 143 may store an identification number or the like for uniquely specifying a customer (customer ID). The identification number for uniquely specifying a customer can be used for providing commodity information specific to the customer, analyzing a sales trend of the items being purchased by the customer, and the like.

### Functional Configuration of Self-Service POS Terminal

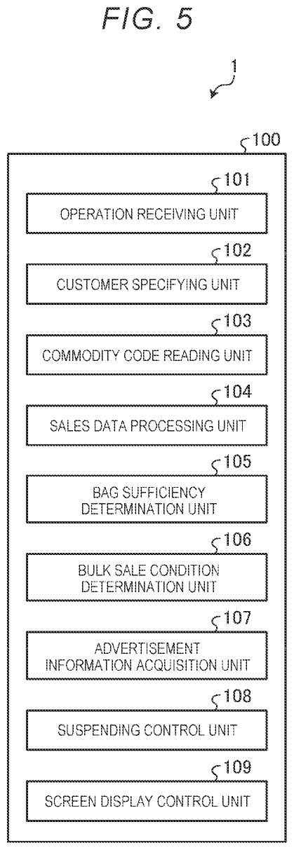

FIG. 5 is a block diagram showing an example of a functional configuration of the self-service POS terminal 1.

The control unit 100 of the self-service POS terminal 1 loads the control program 141 in the RAM 13 and executes the control program 141 to implement an operation receiving unit 101, a customer specifying unit 102, a commodity code reading unit 103, a sales data processing unit 104, a bag sufficiency determination unit 105, a bulk sale condition determination unit 106, an advertisement information acquisition unit 107, a suspending control unit 108, and a screen display control unit 109 shown in FIG. 5 as functional units. Some or all of these described functions may be implemented by dedicated hardware circuits or the like.

The operation receiving unit 101 receives an input operation from a customer via the operation unit 82. Specifically, the operation receiving unit 101 receives an operation (selection) on one of the various screens displayed on the display device 81, and notifies the CPU 11 of the received operation content (the customer's input/selection).

When the customer operating the self-service POS terminal 1 is a member of the store, the customer specifying unit 102 uniquely specifies the customer based on, for example, information registered in a membership card of the customer and read by the card reading unit 6. The customer specifying unit 102 may specify a customer based on code information displayed on a smartphone of the customer and read by the code reading unit 5. The customer specifying unit 102 may specify a customer by performing facial authentication of the customer with a camera installed in the self-service POS terminal 1.

The commodity code reading unit 103 reads identification information of a commodity from the code reading unit 5. The commodity code reading unit 103 is an example of the reading unit.

The sales data processing unit 104 performs various types of processing related to registration processing of the item(s) being purchased by a customer and payment processing of paying for the item(s) purchased by the customer. Specifically, the sales data processing unit 104 dispenses a transaction ID when identification information of the first commodity is read. The sales data processing unit 104 performs commodity registration processing of specifying, from the commodity master 142, the commodity corresponding to the identification information of the commodity read by the commodity code reading unit 103 and registering the commodity information related to the specified commodity in the commodity registration file 143. In addition, if the sales data processing unit 104 receives an input operation for starting payment via the operation unit 82, the sales data processing unit 104 executes payment processing including calculating the total amount of money due for registered commodities and performing settlement operations for the amount of money paid through the deposit and withdrawal unit 4. The payment processing supports not only cash payment via the deposit and withdrawal unit 4 but also cashless settlement by credit cards, electronic money, or the like via the card reading unit 6. The sales data processing unit 104 causes the printing unit 7 to dispense a receipt on which commodity information, a total amount of money due (transaction total), and the payment amount are printed. The sales data processing unit 104 is an example of the registration unit.

The bag sufficiency determination unit 105 determines whether the customer can accommodate all the registered commodities in the bag(s) registered (selected) by the customer prior to the registration of the commodities. Specifically, the bag sufficiency determination unit 105 determines, based on the weight and size of the registered commodities and the size and number of bags selected by the customer, whether all the commodities can be accommodated in the selected bag(s). Specifically, the bag sufficiency determination unit 105 reads, from the commodity master 142, the weight and size of the registered commodities, and uses the capacity and load resistance of each bag selected by the customer to estimate bag sufficiency. Then, the bag sufficiency determination unit 105 determines whether all the registered commodities can be accommodated in the selected bag.

The bulk sale condition determination unit 106 determines whether a commodity registered by a customer satisfies a discount condition based on the bulk sale of item(s). Specifically, the bulk sale condition determination unit 106 determines whether a bulk sale discount condition is satisfied based on commodity codes of the registered commodities and the bulk sale information stored in the commodity master 142.

The advertisement information acquisition unit 107 acquires advertisement information corresponding to the customer, who was specified by the customer specifying unit 102, via the communication unit 16 from a server device or the like connected to the self-service POS terminal 1 via a communication network or the like.

The suspending control unit 108 temporarily suspends (pauses) the commodity registration processing when the operation receiving unit 101 detects that the customer inputs an instruction for suspending the commodity registration processing. When the commodity registration processing is temporarily suspended in this manner, the suspending control unit 108 dispenses a one-time password for releasing the suspending. Instead of dispensing the one-time password, the suspending control unit 108 may cause the printing unit 7 to dispense a receipt on which an identification code for releasing the suspension (pause) is printed. The suspending control unit 108 may also or instead release the suspension based on a face image of the customer (facial recognition).

The screen display control unit 109 controls the display device 81 to display various screens. For example, the screen display control unit 109 cooperates with the operation receiving unit 101 and the sales data processing unit 104 to cause the display device 81 to display various screens for supporting purchases of a commodity.

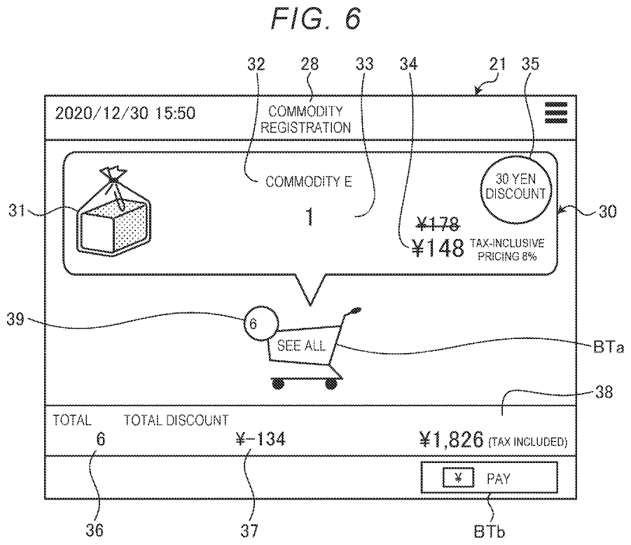

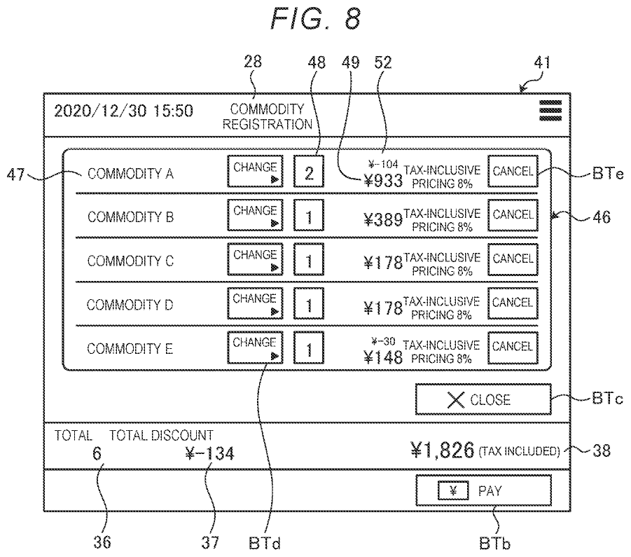

Specifically, the screen display control unit 109 causes the display device 81 to display a current status screen 21 (see FIG. 6) including registered commodity information 30 (see FIG. 6) of a currently registered commodity, a total number indicator 36 and a total amount of money indicator 38 for the registered commodities in a smaller size (screen occupancy) than the registered commodity information 30, and a detail display button BTa (see FIG. 6) for displaying a registration detail screen 41 (see FIG. 8) including a detail list of all the registered commodities. A specific display example will be described later (see FIG. 6).

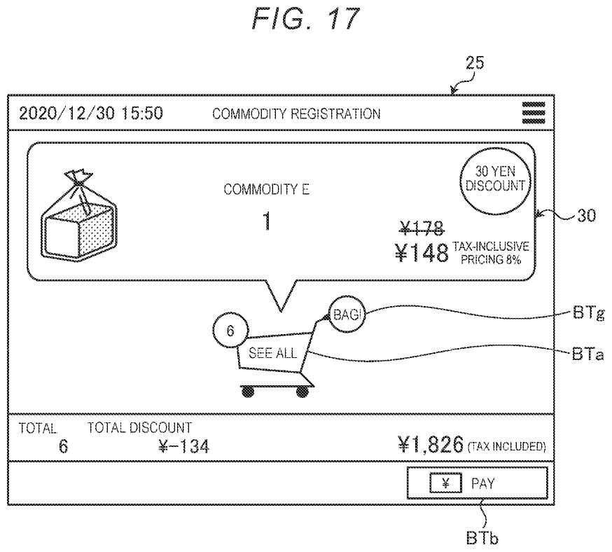

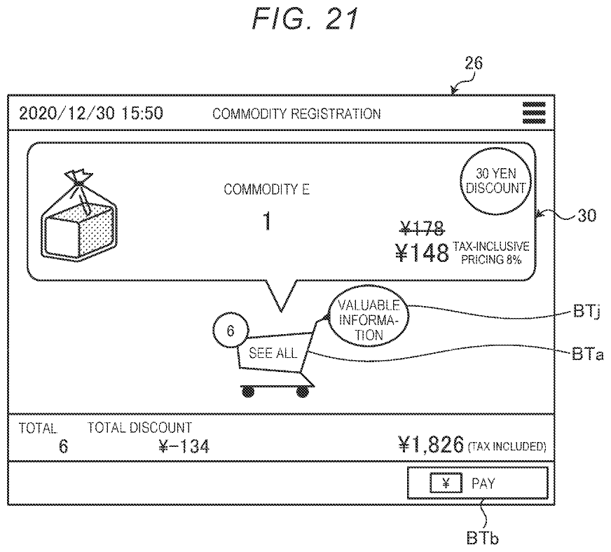

The screen display control unit 109 causes a current status screen to display a payment button BTb (see FIG. 6) for instructing the execution of payment and/or other operation elements (e.g., a bag alert button BTg (see FIG. 17), an advertisement display button BTj (see FIG. 21), etc.) as appropriate for indicating occurrence of an event related to registration of a commodity and accessing detailed information related to the event. Specific display examples of various current screens will be described in conjunction with FIGS. 6, 17, and 21.

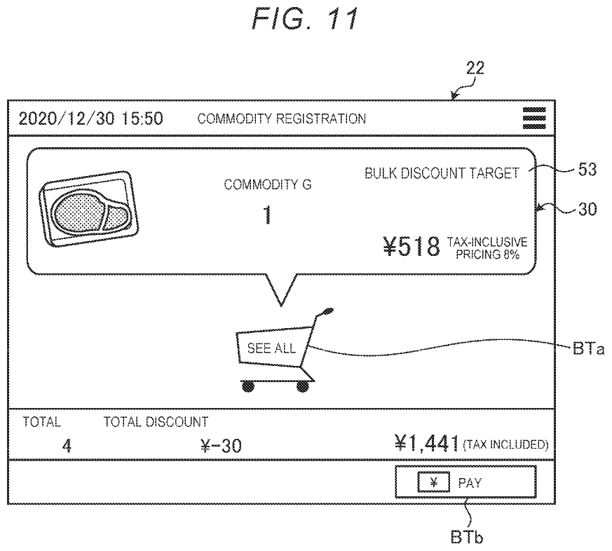

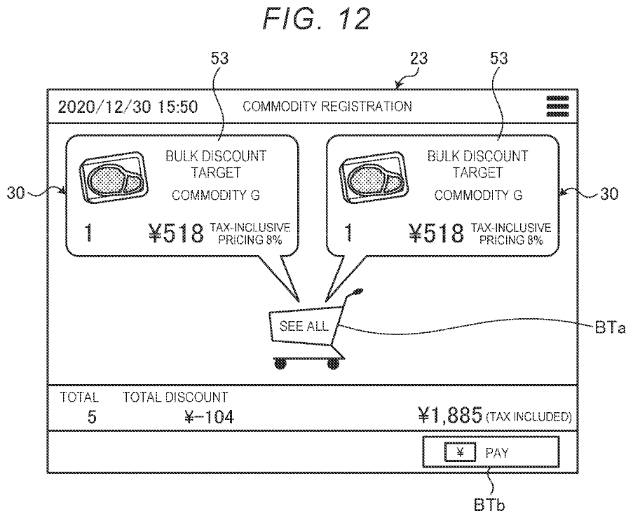

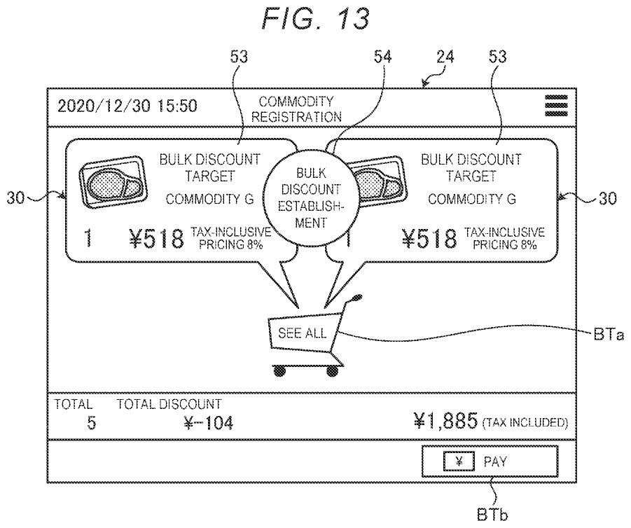

When the sales data processing unit 104 (registration unit) registers a commodity as a bulk discount target, the screen display control unit 109 causes a current status screen 23 (see FIG. 12) to display the registered commodity information 30 related to the commodity as the bulk discount target and the registered commodity information 30 related to the registered commodity as the bulk discount target side by side in the same size on condition that the bulk discount condition has been satisfied. The screen display control unit 109 further displays a bulk discount satisfied icon 54 (see FIG. 13) indicating that the bulk discount condition has been satisfied. A specific display example will be described later (see FIGS. 11, 12, and 13).

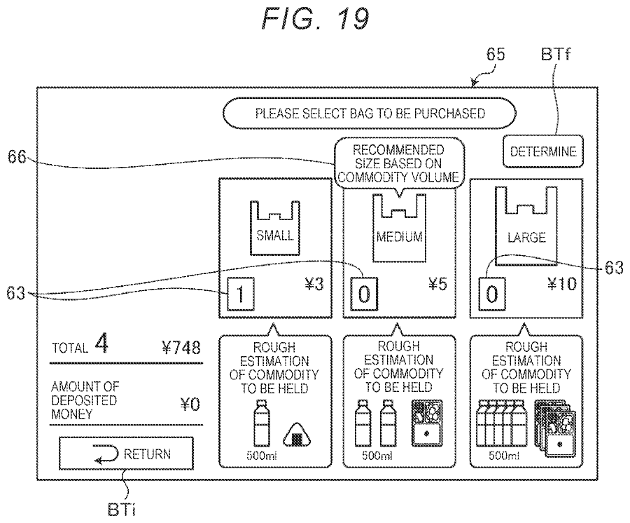

The screen display control unit 109 causes a current status screen 25 to display a bag alert button BTg indicating that bags are insufficient when the bag sufficiency determination unit 105 determines that the commodities registered will not fit in the registered bag(s). A specific display example will be described later (see FIG. 17). If the bag alert button BTg is operated, the screen display control unit 109 causes a bag selection screen 65 to display a purchase number input box 63 for instructing a change or addition of the type and the number of the bags already registered. A specific display example will be described later (see FIG. 19).

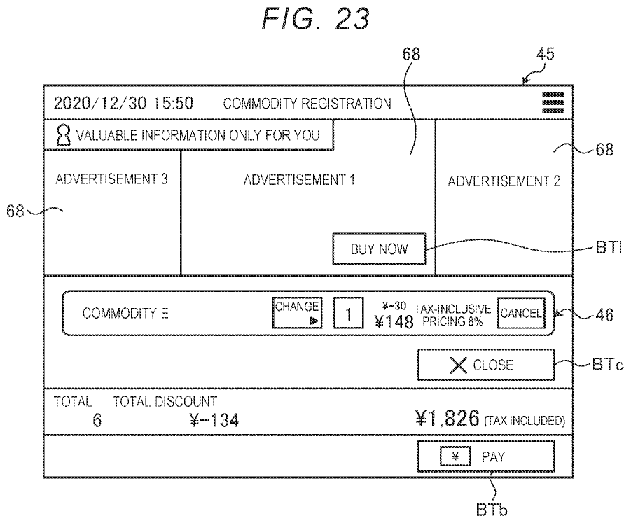

If advertisement information corresponding to the customer specified by the customer specifying unit 102 is acquired, the screen display control unit 109 causes a current status screen to display an advertisement display button BTj (see FIG. 21) indicating that the advertisement information is present (available), and causes an advertisement display screen 45 to display the advertisement information and an operation element for instructing purchase of a commodity related to the advertisement information if the advertisement display button BTj is operated (pressed or otherwise selected). A specific display example will be described later (see FIGS. 21 and 23).

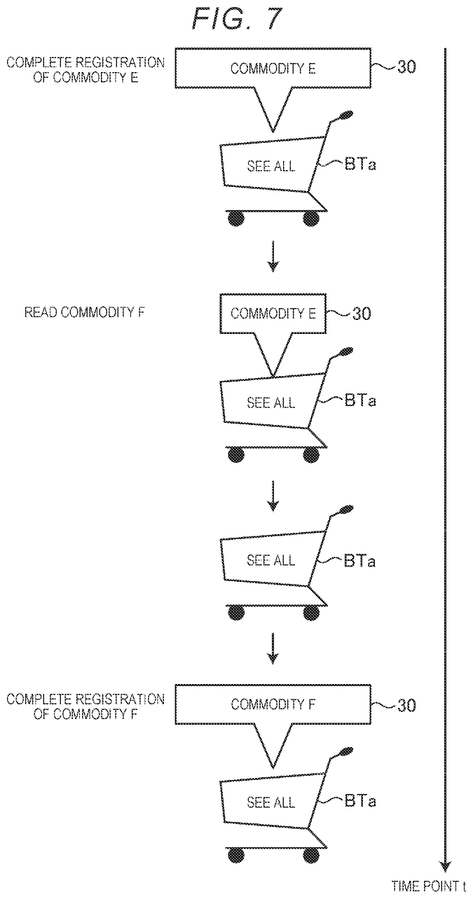

When the sales data processing unit 104 (registration unit) registers a commodity, the screen display control unit 109 displays the registered commodity information 30 displayed on the current status screen with movement corresponding to being accommodated within the detail display button Bta, which is a shopping cart image/icon or the like. A specific display example will be described later (see FIG. 7).

In response to the operation of the detail display button BTa on the current status screen, the screen display control unit 109 causes the display device 81 to display the registration detail screen 41 that includes a registered commodity list 46 including all commodities registered by the sales data processing unit 104 so far on the current status screen. A close button BTc is also shown on or in conjunction with the registration detail screen 41. A specific display example will be described later (see FIG. 8).

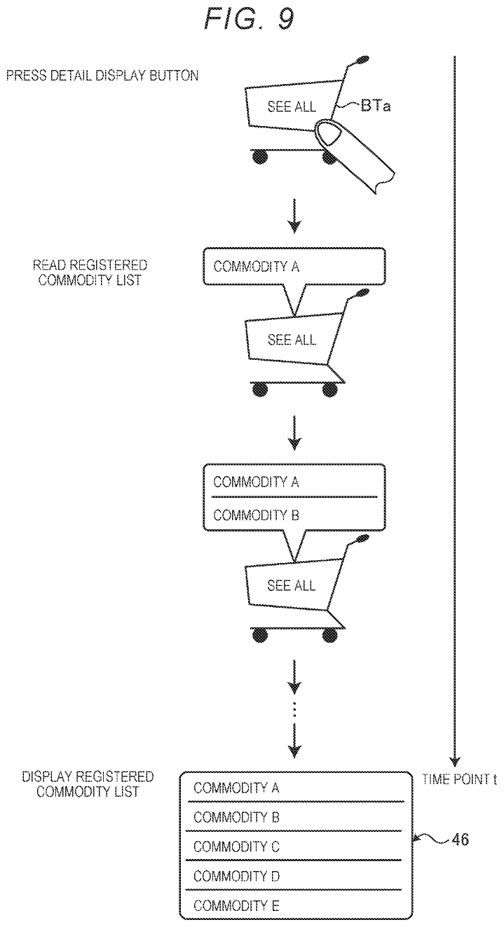

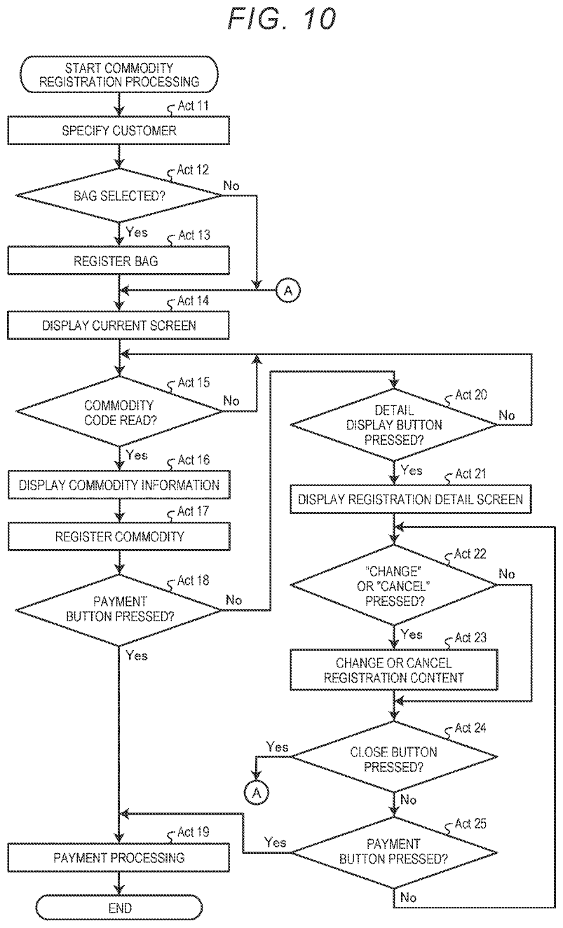

In response to the pressing of the detail display button BTa on the current status screen, the screen display control unit 109 causes the display device 81 to perform an animation display with a movement indicating an extracting, in order of registration (registration order), all the commodities registered by the sales data processing unit 104 so far from the detail display button BTa (shopping cart image), and displays the registration detail screen 41 including the registered commodity list 46. A specific display example will be described later (see FIG. 9).

The screen display control unit 109 may further cause the audio output unit 15 to output a sound or a sound effect corresponding to the screen displayed on the display device 81.

### Screen Display During Commodity Registration

Specific examples of a graphical user interface (GUI) displayed on the display device 81 when the self-service POS terminal 1 performs commodity registration processing will be described with reference to FIGS. 6 to 9. FIG. 6 is a diagram showing an example of a current status screen displayed on the display device of the self-service POS terminal during commodity registration. FIG. 7 is a diagram showing an example of an animation screen (or animation) displayed on the display device of the self-service POS terminal during commodity registration. FIG. 8 is a diagram showing an example of a registration detail screen displayed on the display device of the self-service POS terminal when a detail display button is pressed. FIG. 9 is a diagram showing an example of an animation screen (or animation) displayed on the display device of the self-service POS terminal when the detail display button is pressed.

The screen display control unit 109 of the self-service POS terminal 1 causes the display device 81 to initially display a start screen. Various buttons corresponding to a main menu are displayed on the start screen. The main menu options include, for example, “read member information”, “purchase bag”, and “call store clerk”. The customer presses a button indicating the function the customer wants to perform from among various buttons displayed on the main menu.

For example, when the customer is a member of the store, the customer selects “read member information” from the main menu prior to the registration of a commodity. Thereafter, the customer holds a membership card identifying himself or herself over the reading window 51 of the self-service POS terminal 1 and causes the code reading unit 5 to read the membership card. Alternatively, the customer inserts the membership card specifying himself or herself into the card insertion slot 61 and causes the card reading unit 6 to read the membership card. The code reading unit 5 or the card reading unit 6 specifies the customer by reading a member code of the customer registered in the membership card. By specifying the customer, the self-service POS terminal 1 provides advertisement information corresponding to the customer, gives points corresponding to a shopping total amount of money, and the like.

Subsequently, if the customer holds the purchased commodity over the reading window 51 of the self-service POS terminal 1, the code reading unit 5 reads a code symbol attached to the commodity. Then, the screen display control unit 109 causes the display device 81 to display the current status screen 21 shown in FIG. 6. The current status screen 21 is an example of a first display screen.

The current status screen 21 displays a screen title 28 indicating that a commodity is being registered (commodity registration is currently on-going), the registered commodity information 30 for a commodity just registered, the total number indicator 36 for the total number of registered commodities in transaction, a total discount amount indicator 37 for the total discount applicable to the transaction, and the total amount of money indicator 38 for the amount of money due for the registered items in the transaction so far. The total number indicator 36, the total discount amount indicator 37, and the total amount of money indicator 38 are all displayed in a size smaller than that of the registered commodity information 30. In other words, the registered commodity information 30 is displayed in a size larger than that of each of the total number indicator 36, the total discount amount indicator 37, and the total amount of money indicator 38.

The detail display button BTa when pressed/selected is for instructing display of a detail list of registered commodities, the payment button BTb, and a total number icon 39 are displayed on the current status screen 21.

The registered commodity information 30 displays, in a graphical balloon starting from the detail display button BTa, commodity information for the commodity currently just registered. The registered commodity information 30 includes a commodity icon 31, a commodity name 32, a quantity 33, a price 34, and a discount amount 35. The screen display control unit 109 acquires these pieces of commodity information from the commodity master 142 and displays these pieces of commodity information as the registered commodity information 30.

The total number indicator 36, the total discount amount indicator 37, and the total amount of money indicator 38 correspond to the number of commodities in the transaction and the amount of money due in the transaction as calculated by the sales data processing unit 104. These pieces of information are displayed in an aligned state (in a row) at positions on a lower portion of the current status screen 21.

The detail display button BTa is an icon or pictogram depicting a shopping cart, shopping basket, shopping bag, or the like (referred to collectively as an accommodation body) that may be used in the store to hold items being purchased by the customer. In the example of FIG. 6, the detail display button BTa has a shape depicting a shopping cart. In other examples, the detail display button BTa may have a shape of another type of accommodation body such as a shopping basket or a bag. The detail display button BTa also serves as a button for instructing the display of a detail list of the registered commodities, and therefore, the detail display button BTa is provided with, for example, a label “see all”. The detail display button BTa is an example of the first operation element.

The payment button BTb is an operation element for instructing the sales data processing unit 104 of the self-service POS terminal 1 to begin payment processing. After the reading of code symbols of all the commodities in the transaction has been completed, the customer presses the payment button BTb to cause the self-service POS terminal 1 to perform the payment processing. The payment button BTb is displayed at a position such as a lower right corner of the current status screen 21.

The icon 39 is an icon indicating the total number of registered commodities. The icon 39 is displayed in a vicinity of the detail display button BTa. The customer can check the number of commodities registered up to now by checking the 39. Since the information indicated by the icon 39 overlaps with the total number indicator 36 described above, the display of the total number indicator 36 may be omitted in some examples.

The screen display control unit 109 performs an animation display depicting the registered commodity information 30 being added (moved) into the detail display button BTa once a commodity code of the next commodity has been read.

For example, as shown in FIG. 7, the registered commodity information 30 displayed after a commodity code of a commodity E has been read. After the sales data processing unit 104 completes the registration of the commodity E the corresponding commodity information 30 is gradually reduced in size and moved to indicate the commodity E is moved into the detail display button BTa once the commodity code of the next commodity F is read. Once the sales data processing unit 104 completes the registration of the commodity F, the registered commodity information 30 indicating commodity information of the commodity F is displayed in a normal (full) initial size.

By performing the animation display with such a movement, the accommodation of the registered commodity within the accommodation body can be visualized, and thus the customer can reliably recognize that the commodity being purchased by the customer is successfully registered.

When it is detected that the detail display button BTa is pressed on the current status screen 21, the screen display control unit 109 causes the display device 81 to display the registration detail screen 41 shown in FIG. 8. The registration detail screen 41 is an example of the second display screen.

The registration detail screen 41 displays the screen title 28 indicating that commodity registration is on-going, the registered commodity list 46, the total number indicator 36, the total discount amount of money indicator 37, and the total amount of money indicator 38.

Further, the payment button BTb and the close button BTc are displayed on the registration detail screen 41.

The registered commodity list 46 is a detailed list of commodity information of all the commodities registered at the current time point. The registered commodity list 46 is displayed in the form of one commodity type (code) per line. The registered commodity list 46 includes a commodity name 47, a quantity indicator 48, a price 49, and a discount amount 52. In the registered commodity list 46, commodity information is displayed from the bottom to the top in order of registration of commodities. That is, the commodity E displayed in the lowest row of the registered commodity list 46 is the latest registered commodity. If the number of registered commodities is large and all the registered commodities do not fit in one screen, the customer can scroll the registered commodity list 46 by swiping the registered commodity list 46 in an upper-lower direction and view the commodity information of all the registered commodities.

The registered commodity list 46 includes change buttons BTd and cancel buttons BTe.

The change button BTd is an operation element for instructing the self-service POS terminal 1 that a quantity of a commodity is required to be changed. The change button BTd is displayed for each commodity displayed in the registered commodity list 46. When it is detected that a change button BTd is pressed, the sales data processing unit 104 causes the screen display control unit 109 to display, from a box of the quantity indicator 48 adjacent to a right side of the pressed change button BTd, a pop-up window in which numbers indicating quantities are arranged. Then, the sales data processing unit 104 re-registers the quantity selected from the pop-up window by the customer as the changed commodity and quantity.

The cancel button BTe is an operation element for instructing the self-service POS terminal 1 to cancel the registration of a commodity. The cancel button BTe is displayed for each commodity displayed on the registered commodity list 46. When it is detected that the cancel button BTe is pressed, the sales data processing unit 104 cancels the registration of the commodity in the row of the pressed cancel button BTe. Then, the screen display control unit 109 deletes the display of the cancelled commodity from the registered commodity list 46.

Further, the close button BTc and the payment button BTb are displayed on the registration detail screen 41. The close button BTc is an operation element for returning the registration detail screen 41 to the current status screen 21. When it is detected that the close button BTc is pressed, the screen display control unit 109 of the self-service POS terminal 1 causes the display device 81 to display the current status screen 21 (see FIG. 6).

The payment button BTb is an operation element for instructing the sales data processing unit 104 of the self-service POS terminal 1 to execute payment processing. That is, the payment button BTb has the same function as the payment button BTb displayed on the current status screen 21. After the registration of all the commodities is completed, the customer can instruct the execution of the payment processing on the registration detail screen 41 without returning to the current status screen 21 again after the screen display is changed from the current status screen 21 to the registration detail screen 41 in order to check the registration content.

In response to the pressing of the detail display button BTa on the current status screen 21, the screen display control unit 109 displays the registration detail screen 41 by performing an animation display depicting a movement for extracting all the registered commodities in the registration order from the detail display button BTa depicting the accommodation body.

For example, as shown in FIG. 9, if the detail display button BTa is pressed, commodity information of a commodity A registered earliest is extracted from the detail display button BTa. Then, the commodity information is extracted in registration time order, and the registration detail screen 41 (see FIG. 8) including the registered commodity list 46 is eventually displayed.

By performing the animation display with such a movement, the removal of registered items from the accommodation body can be visualized, and thus the customer can reliably recognize the present content of the transaction to be purchased by the customer.

### Flow of Commodity Registration Processing Performed by Self-Service POS Terminal

The flow of the commodity registration processing performed by the self-service POS terminal 1 will be described with reference to FIG. 10. FIG. 10 is a flowchart showing an example of commodity registration processing performed by a self-service POS terminal 1.

The customer specifying unit 102 identifies the customer who uses the self-service POS terminal 1 (Act 11). The customer can be identified by various methods such as those already described above.

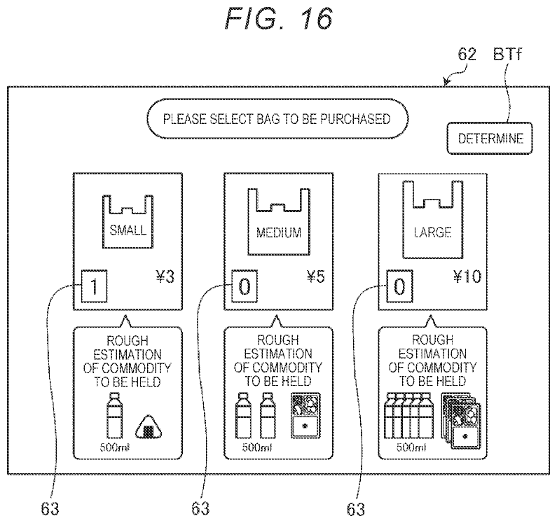

The bag sufficiency determination unit 105 determines whether the customer selects a bag to be purchased (Act 12). If the customer selects a bag to be purchased (Act 12: Yes), the processing proceeds to Act 13. If the customer does not select a bag to be purchased (Act 12: No), the processing proceeds to Act 14. Note that selection of the bag(s) to be purchased by a customer can be determined by selection of one or more bags on a bag selection screen 62 (see FIG. 16).

If it is determined in Act 12 that the customer selects a bag to be purchased, the sales data processing unit 104 registers the bag(s) selected by the customer (Act 13).

The screen display control unit 109 causes the display device 81 to display the current status screen 21 (Act 14). At this time, if the customer selects a bag to be purchased, commodity information (commodity icon, commodity name, quantity, and price) related to the bag selected by the customer is displayed in the registered commodity information 30 shown in FIG. 6. If the customer selects a bag to be purchased, the current status screen 21 in which the registered commodity information 30 is not displayed is shown.

The commodity code reading unit 103 determines whether a commodity code is read (Act 15). If a commodity code is read (Act 15: Yes), the processing proceeds to Act 16. On the other hand, if a commodity code is not read (Act 15: No), Act 15 is repeated.

If it is determined in Act 15 that the commodity code is read, the screen display control unit 109 displays the registered commodity information 30 on the current status screen 21 (Act 16).

Subsequently, the sales data processing unit 104 registers the commodity corresponding to the read commodity code (Act 17).

The operation receiving unit 101 determines whether the payment button BTb is pressed (Act 18). If the payment button BTb is pressed (Act 18: Yes), the processing proceeds to Act 19. On the other hand, if the payment button BTb is not pressed (Act 18: No), the processing proceeds to Act 20.

If it is determined in Act 18 that the payment button BTb is pressed, the sales data processing unit 104 performs payment processing (Act 19). Thereafter, the self-service POS terminal 1 ends the processing in FIG. 10.

In Act 18, if it is determined that the payment button BTb is not pressed, the operation receiving unit 101 next determines whether the detail display button BTa is pressed (Act 20). If the detail display button BTa is pressed (Act 20: Yes), the processing proceeds to Act 21. On the other hand, if the detail display button BTa is not pressed (Act 20: No), the processing returns to Act 15.

If it is determined in Act 20 that the detail display button BTa is pressed, the screen display control unit 109 displays the registration detail screen 41 including the registered commodity list 46 (Act 21).

The operation receiving unit 101 determines whether the change button BTd or the cancel button BTe has been pressed on the registration detail screen 41 (Act 22). If the change button BTd or the cancel button BTe is pressed (Act 22: Yes), the processing proceeds to Act 23. On the other hand, if the change button BTd or the cancel button BTe is not pressed (Act 22: No), the processing proceeds to Act 24.

If it is determined in Act 22 that the change button BTd or the cancel button BTe is pressed, the sales data processing unit 104 performs change processing or cancel processing corresponding to the pressed button (Act 23). If the change button BTd is pressed, the sales data processing unit 104 changes the quantity of a commodity corresponding to the pressed change button BTd to a quantity designated by the customer. If the cancel button BTe is pressed, the sales data processing unit 104 cancels the registration of a commodity corresponding to the pressed cancel button BTe and deletes the commodity from the registered commodity list 46.

If it is determined in Act 22 that the change button BTd or the cancel button BTe is not pressed, or after Act 23, the operation receiving unit 101 next determines whether the close button BTc is pressed (Act 24). If the close button BTc is pressed (Act 24: Yes), the processing returns to Act 14. On the other hand, if the close button BTc is not pressed (Act 24: No), the processing proceeds to Act 25.

If it is determined in Act 24 that the close button BTc is not pressed, the operation receiving unit 101 next determines whether the payment button BTb is pressed (Act 25). If the payment button BTb is pressed (Act 25: Yes), the processing proceeds to Act 19. On the other hand, if the payment button BTb is not pressed (Act 25: No), the processing returns to Act 22.

### Commodity Registration Processing of Bulk Discount Commodity Performed by Self-Service POS Terminal

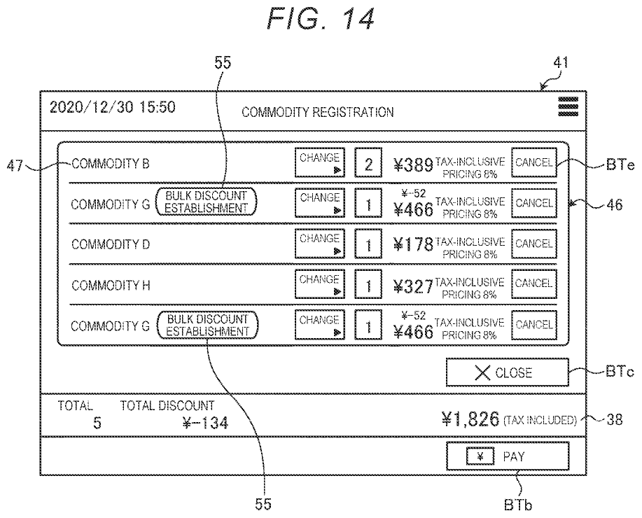

With reference to FIGS. 11 to 14, specific examples of a graphical user interface (GUI) displayed on the display device 81 when performing commodity registration processing of a bulk discount commodity (an item for which a discount occurs when purchased in bulk) will be described. FIG. 11 is a diagram showing an example of a screen displayed on the display device of the self-service POS terminal 1 when a bulk discount commodity is registered. FIG. 12 is a diagram showing an example of a screen displayed on the display device of the self-service POS terminal 1 when a plurality of bulk discount commodities are registered. FIG. 13 is a diagram showing an example of a screen displayed on the display device of the self-service POS terminal 1 when the bulk discount condition is satisfied. FIG. 14 is a diagram showing an example of a registration detail screen displayed on the display device of the self-service POS terminal 1 when the bulk discount condition is satisfied.

When a commodity is a bulk discount target and is registered, the screen display control unit 109 causes the display device 81 to display a current status screen 22 shown in FIG. 11. A screen configuration of the current status screen 22 is generally the same as a screen configuration of the current status screen 21 (see FIG. 6) described above. In the registered commodity information 30 displayed in a balloon from the detail display button BTa, bulk discount commodity identification information 53 is displayed together with the various kinds of commodity information such as described with reference to FIG. 6. The bulk discount commodity identification information 53 is a tag indicating that the commodity is a bulk discount target (that is, a potential discount is associated with the commodity).

When the registration of the commodity is repeated and the bulk discount target is registered again, the screen display control unit 109 causes the display device 81 of the self-service POS terminal 1 to display the current status screen 23 shown in FIG. 12. FIG. 12 shows that a commodity G (that is a bulk discount target) has been registered again (twice in this instance). The screen display control unit 109 causes the current status screen 23 to display the registered commodity information 30 indicating the commodity information of the previously registered commodity and the newly registered commodity G side by side in the same size as each other. Since pieces of exactly the same registered commodity information 30 are displayed side by side on the current status screen 23, the screen display control unit 109 may display the registered commodity information 30 of the commodities registered in the past by, for example, displaying the registered commodity information 30 in different colors. Therefore, the fact that multiple commodities registered at different times are targets of the bulk discount may be displayed in an easy-to-understand manner.

Then, the screen display control unit 109 displays a current status screen 24 shown in FIG. 13 on condition that the bulk sale condition determination unit 106 determines that the bulk discount condition is satisfied. The current status screen 24 is obtained by superimposing, on the current status screen 23, the bulk discount satisfied icon 54 indicating that the bulk discount condition has been satisfied. Note that the example shown here is an example in which, when two commodities G are purchased, these two commodities G become targets of the bulk discount. When three or more purchased commodities are targets of the bulk discount, the screen display control unit 109 also similarly displays the registered commodity information for the three commodities side by side in the same size. By viewing the bulk discount satisfied icon 54 displayed on the current status screen 24, the customer can easily confirm that the bulk discount condition has been satisfied. In addition, if the bulk discount condition is not satisfied, for example, if two target commodities are registered when bulk the purchase of three commodities is required for the discount to be received, the registered commodity information may also be displayed side by side in the same size to call the attention of the customer to the discount opportunity not being satisfied. In this case, when one more target commodity is purchased, reception of the bulk discount is desirably displayed in the current status screen 24. Each of the current status screens 22, 23, and 24 is an example of the first display screen.

If it is detected that the detail display button BTa is pressed on the current status screen 24, the screen display control unit 109 causes the display device 81 to display a registration detail screen 42 shown in FIG. 14. The registration detail screen 42 is an example of the second display screen.

A screen configuration of the registration detail screen 42 is generally the same as the screen configuration of the registration detail screen 41 (see FIG. 8) described above. In a column of a commodity that is a bulk discount target and displayed in the registered commodity list 46, bulk discount establishment information 55 indicating that a bulk discount condition has been satisfied is displayed. As described above, the registered commodity list 46 is displayed from the bottom to the top in the order in which the commodity codes are read, and the screen display control unit 109 may display the registered commodity list 46 by changing the order so that the commodities for which a bulk discount establishment information 55 is attached are adjacent to each other when the bulk discount condition has been satisfied.

### Flow of Commodity Registration Processing of Bulk Discount Commodity Performed by Self-Service POS Terminal

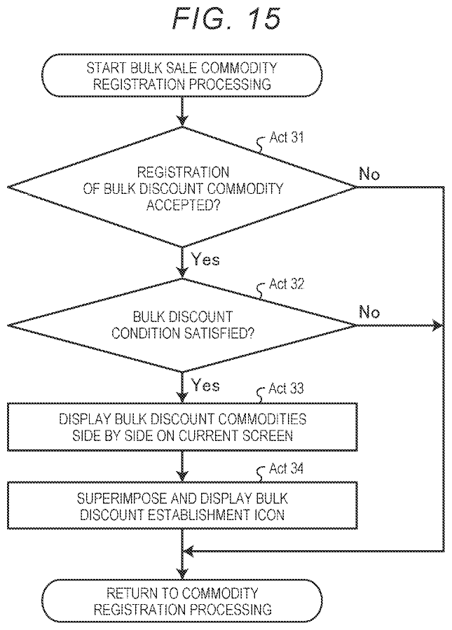

A flow of commodity registration processing of a bulk discount commodity performed by the self-service POS terminal 1 will be described with reference to FIG. 15. FIG. 15 is a flowchart showing an example of the commodity registration processing of the bulk discount commodity performed by the self-service POS terminal 1. The flowchart of FIG. 15 shows a flow of processing performed when the commodity registered in Act 17 of the flowchart of FIG. 10 for performing the commodity registration processing is a commodity that is a bulk discount target.

The sales data processing unit 104 determines whether the registration of the bulk discount commodity is accepted (Act 31). If registration of the bulk discount commodity is accepted (Act 31: Yes), the processing proceeds to Act 32. On the other hand, if the registration of the bulk discount commodity is not accepted (Act 31: No), the self-service POS terminal 1 ends the processing in FIG. 15 and returns to Act 18 in FIG. 10.

If it is determined in Act 31 that the registration of the bulk discount commodity is accepted, the sales data processing unit 104 next determines whether the bulk discount condition is satisfied (Act 32). If the bulk discount condition is satisfied (Act 32: Yes), the processing proceeds to Act 33. On the other hand, if the bulk discount condition is not satisfied (Act 32: No), the self-service POS terminal 1 ends the processing in FIG. 15 and returns to Act 18 in FIG. 10.

If it is determined in Act 32 that the bulk discount condition is satisfied, the screen display control unit 109 next causes the current status screen to display the registered commodity information 30 of the registered bulk discount commodities side by side in the same size (Act 33).

The screen display control unit 109 superimposes and displays the bulk discount satisfied icon 54 on the current status screen displayed in Act 33 (Act 34). Thereafter, the self-service POS terminal 1 ends the processing in FIG. 15 and returns to Act 18 in FIG. 10.

If the detail display button BTa is pressed and the screen shifts to the registration detail screen when a bulk discount condition is satisfied, the screen display control unit 109 performs processing of displaying the bulk discount establishment information 55 in the registered commodity information 30 of a commodity that is the bulk discount target.

### Screen Display When Capacity of Bag is Insufficient

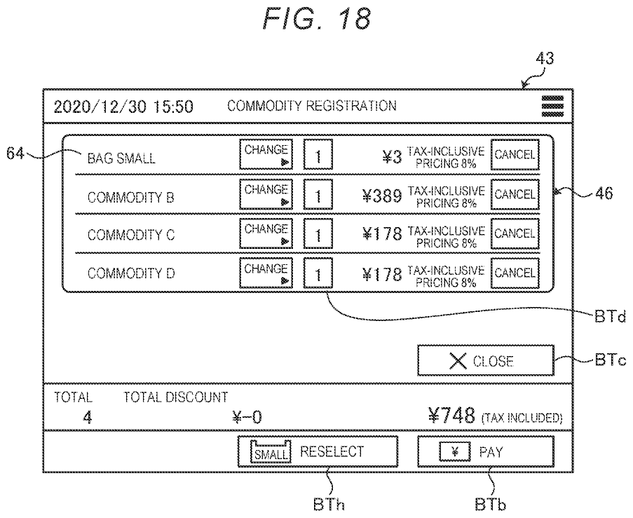

Next, with reference to FIGS. 16 to 19, specific examples of a GUI will be described. The GUI is displayed on the display device 81 when the capacity of the bags initially selected by the customer to accommodate the items to be purchased is found (estimated) to be insufficient during the commodity registration processing performed at the self-service POS terminal 1. FIG. 16 is a diagram showing an example of a screen for selecting the type and number of bags. FIG. 17 is a diagram showing an example of a current status screen displayed when the bags are found to be insufficient during commodity registration. FIG. 18 is a diagram showing an example of a registration detail screen displayed when a bag alert button is pressed. FIG. 19 is a diagram showing an example of a screen displayed when a bag is reselected.

Generally, when a customer wants to buy a bag for accommodating the purchased item(s), the customer selects the bags to be bought before starting the registration of commodities (code symbol reading) at the self-service POS terminal 1. For example, on a main screen displayed on the display device 81 of the self-service POS terminal 1 at a start point, a menu option “purchase bag” can be selected. At this time, the screen display control unit 109 causes the display device 81 to display the bag selection screen 62 shown in FIG. 16.

The bag selection screen 62 displays windows indicating the size and price of each available bag type, depictions of the amount of commodities that can be stored in the bags of respective sizes, and a determination button BTf. The purchase number input boxes 63 for designating the number of each bag type are displayed inside the window corresponding to each bag type.

The purchase number input box 63 is for inputting the number of bags to be purchased. When it is detected that the purchase number input box 63 is pressed, the screen display control unit 109 of the self-service POS terminal 1 displays, from the pressed purchase number input box 63, a pop-up window in which numbers indicating quantities are aligned. Then, the sales data processing unit 104 registers the number selected by the customer from the pop-up window as the purchase number for bags of the corresponding size. The customer can thus purchase bags of different sizes by repeating the same operation.

The determination button BTf is an operation element that notifies the self-service POS terminal 1 that the input to the purchase number input box 63 is completed. The sales data processing unit 104 determines the registration information of the bag by detecting that the determination button BTf is pressed. An actual bag can be displayed, for example, in a vicinity of the self-service POS terminal 1, and the customer obtains, from a display location, bags corresponding to the size and the number registered by the customer.

Thereafter, the customer handles by himself or herself a commodity to be purchased to move the commodity over the reading window 51 of the self-service POS terminal 1 and causes the code reading unit 5 to read a code symbol attached to the commodity. Then, the screen display control unit 109 causes the display device 81 to display the current status screen 25 shown in FIG. 17. The current status screen 25 is an example of the first display screen.

Every time a commodity is registered, the bag sufficiency determination unit 105 of the self-service POS terminal 1 checks whether all the commodities registered so far can be accommodated in the bags selected by the customer. When it is determined that there is a possibility that the items cannot be accommodated in the bags, the bag sufficiency determination unit 105 causes the screen display control unit 109 to display the bag alert button BTg on the current status screen 25 in addition to each piece of information described in FIG. 6.

The bag alert button BTg is displayed in a vicinity of the detail display button BTa, and is an icon indicating that there is a possibility that the commodities registered so far cannot be accommodated in the bags selected by the customer. The bag alert button BTg also serves as an operation button, and by pressing the bag alert button BTg, the customer can reselect bags as described later (see FIG. 19). In order to reliably inform the customer that the bag alert button BTg is displayed, the screen display control unit 109 may cause the audio output unit 15 to output a sound or a sound effect indicating that the bag alert button BTg is displayed. The bag alert button BTg is an example of a second operation element.

If the operation receiving unit 101 detects that the bag alert button BTg is pressed on the current status screen 25, the operation receiving unit 101 causes the screen display control unit 109 to display the bag selection screen 65 on the display device 81.

The bag selection screen 65 displays the total number of registered commodities, the total amount of money, and the amount of deposited money. In addition, each piece of information related to the selection of the bag described in FIG. 16 is displayed on the bag selection screen 65. Further, a return button BTi is displayed on the bag selection screen 65.

The customer reselects a bag by operating the purchase number input box 63 displayed on the bag selection screen 65 as described in FIG. 16. Then, when the reselection of the bag(s) is completed, the determination button BTf is pressed. The operation receiving unit 101 detects that the determination button BTf is pressed, and causes the sales data processing unit 104 to check a content of the reselection of the bag.

In some examples, the bag sufficiency determination unit 105 of the self-service POS terminal 1 may not only determine that the bag is insufficient, but also propose the size and the number of bags additional required for the customer to accommodate all the commodities registered so far. Specifically, the bag sufficiency determination unit 105 reads the weights and sizes of all the commodities registered so far from the commodity master file 142 and compares the weights and sizes with the capacities of the bags of respective sizes. Then, the bag sufficiency determination unit 105 calculates the size of the bags that could accommodate all the commodities. The calculated size of the bag is displayed on the bag selection screen 65 as, for example, proposal information 66 shown in FIG. 19.

The return button BTi is an operation element for returning to the current status screen 25. The customer presses the return button BTi after the reselection of the bags is completed or after it is determined that reselection of a bag is not required. If the operation receiving unit 101 detects that the return button BTi is pressed, the operation receiving unit 101 causes the screen display control unit 109 to display the current status screen 25 on the display device 81.

If the operation receiving unit 101 detects that the detail display button BTa is pressed on the current status screen 25, the operation receiving unit 101 causes the screen display control unit 109 to display a registration detail screen 43 on the display device 81. The registration detail screen 43 is an example of the second display screen.

The registration detail screen 43 displays the information described with reference to FIG. 8. That is, a detail list of the commodity information of all the commodities registered up to the current time point is displayed from the bottom to the top in the registered commodity list 46 in the order of registration. At this time, the screen display control unit 109 generally displays the bag registration information 64, which is the commodity information related to the selected bags, in an uppermost stage of the registered commodity list 46. This is because there is a high possibility that the customer reselects a bag in response to an alert indicating that the bag capacity is insufficient, and thus operability is impaired if the commodity information related to the bag is not displayed in the registered commodity list 46 displayed at this time. When the customer selects bags having a plurality of sizes, for example, bags having a small size and a medium size, the screen display control unit 109 displays the bag registration information 64 in the upper two rows of the registered commodity list 46.

The registration detail screen 43 displays a bag reselection button BTh. The customer can reselect a bag by pressing either the bag reselection button BTh or the change button BTd that is displayed in a row of the bag registration information 64.

If the operation receiving unit 101 detects that the bag reselection button BTh or the change button BTd that is displayed in the row of the bag registration information 64 is pressed, the operation receiving unit 101 causes the screen display control unit 109 to display the bag selection screen 65 on the display device 81.

### Flow of Bag Sufficiency Determination Processing Performed by Self-Service POS Terminal

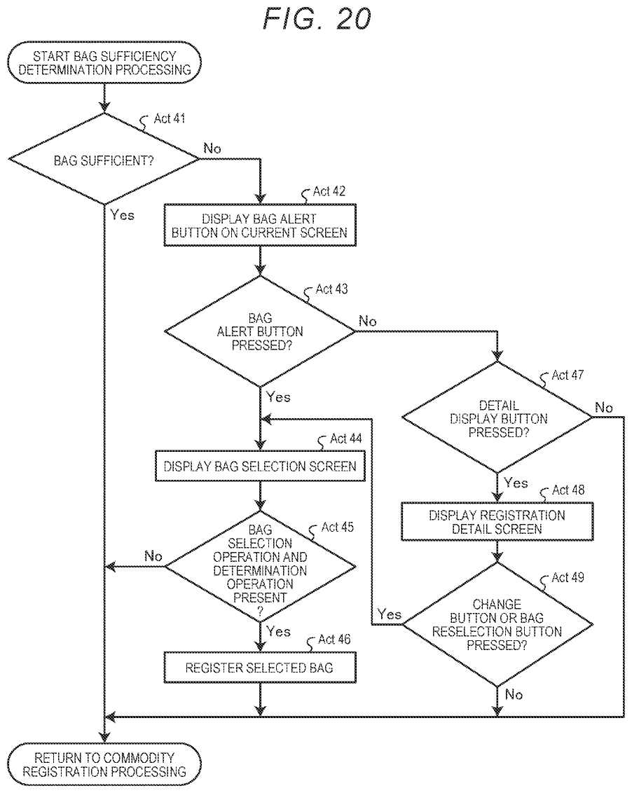

A flow of bag sufficiency determination processing performed by the self-service POS terminal 1 will be described with reference to FIG. 20. FIG. 20 is a flowchart showing an example of the flow of the bag sufficiency determination processing performed by the self-service POS terminal 1. The flowchart of FIG. 20 is the processing executed when a bag is registered in Act 13 of the flowchart representing the commodity registration processing shown in FIG. 10.

The bag sufficiency determination unit 105 executes the processing shown in FIG. 20 every time a new commodity is registered. First, the bag sufficiency determination unit 105 determines whether the bags registered by the customer are sufficient to accommodate all the commodities registered so far (Act 41). If it is determined that the bags are sufficient (Act 41: Yes), the self-service POS terminal 1 ends the processing in FIG. 20 and returns to Act 18 in FIG. 10. On the other hand, if it is determined that the bags are not sufficient (Act 41: No), the processing proceeds to Act 42.

If it is determined in Act 41 that the bags are not sufficient, the screen display control unit 109 displays the bag alert button BTg on the current status screen 25 (Act 42).

The operation receiving unit 101 determines whether the bag alert button BTg is pressed (Act 43). If the bag alert button BTg is pressed (Act 43: Yes), the processing proceeds to Act 44. On the other hand, if the bag alert button BTg is not pressed (Act 43: No), the processing proceeds to Act 47.

If it is determined in Act 43 that the bag alert button BTg is pressed, the screen display control unit 109 next causes the display device 81 to display the bag selection screen 65 (see FIG. 19) (Act 44).

The operation receiving unit 101 determines whether the purchase number input box 63 is operated and the determination button BTf is pressed on the bag selection screen 65 (Act 45). If the purchase number input box 63 is operated and the determination button BTf is pressed (Act 45: Yes), the processing proceeds to Act 46. On the other hand, if the purchase number input box 63 is not operated and the determination button BTf is not pressed (Act 45: No), the self-service POS terminal 1 ends the processing in FIG. 20 and returns to Act 18 in FIG. 10.

The sales data processing unit 104 registers the selected bag (Act 46). Thereafter, the self-service POS terminal 1 ends the processing in FIG. 20 and returns to Act 18 in FIG. 10.

Returning to Act 43, if it is determined in Act 43 that the bag alert button BTg is not pressed, the operation receiving unit 101 determines whether the detail display button BTa is pressed (Act 47). If it is determined that the detail display button BTa is pressed (Act 47: Yes), the processing proceeds to Act 48. On the other hand, if it is determined that the detail display button BTa is not pressed (Act 47: No), the self-service POS terminal 1 ends the processing in FIG. 20 and returns to Act 18 in FIG. 10.

If it is determined in Act 47 that the detail display button BTa is pressed, the screen display control unit 109 causes the display device 81 to display the registration detail screen 43 (see FIG. 18) (Act 48).

The operation receiving unit 101 determines whether the change button BTd or the bag reselection button BTh is pressed on the registration detail screen 43 (Act 49). If the change button BTd or the bag reselection button BTh is pressed (Act 49: Yes), the processing proceeds to Act 44. On the other hand, if the change button BTd or the bag reselection button BTh is not pressed (Act 49: No), the self-service POS terminal 1 ends the processing in FIG. 20 and returns to Act 18 in FIG. 10.

### Advertisement Information Display Processing Performed by Self-Service POS Terminal

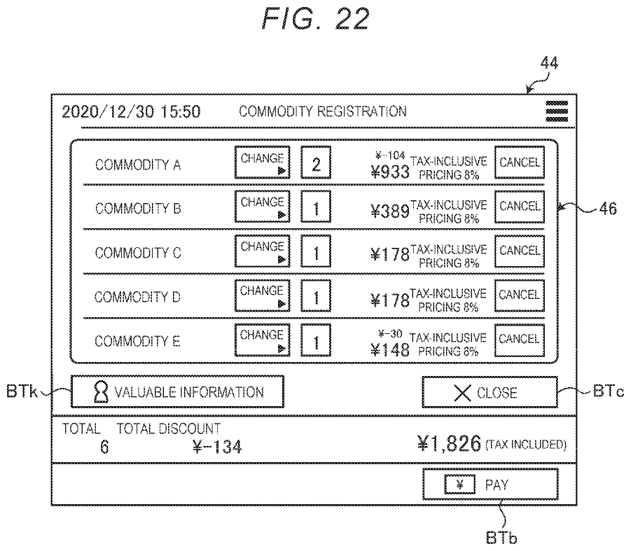

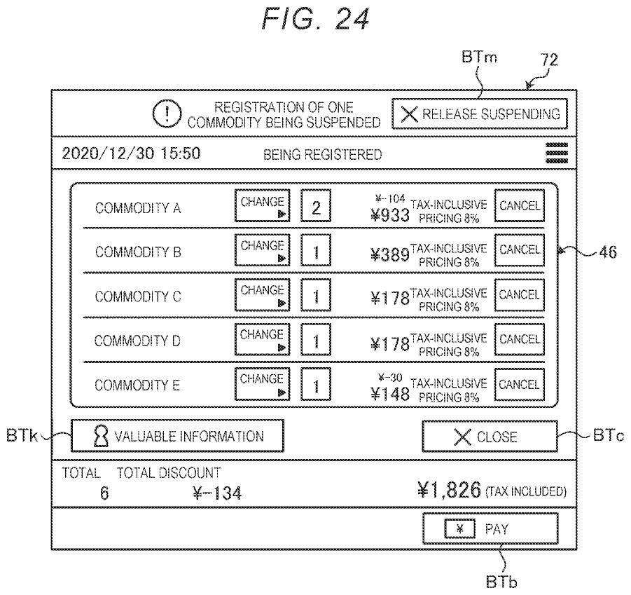

Specific examples of a GUI displayed on the display device 81 when the self-service POS terminal 1 promotes advertisement information to a customer will be described with reference to FIGS. 21 to 24. FIG. 21 is a diagram showing an example of a current status screen displayed when advertisement information for a customer is present (available) during commodity registration. FIG. 22 is a diagram showing an example of a registration detail screen displayed when the advertisement information for a customer is present during the commodity registration. FIG. 23 is a diagram showing an example of a screen displayed when the advertisement information is viewed. FIG. 24 is a diagram showing an example of a screen displayed when registration of a commodity is suspended.

When the advertisement information acquisition unit 107 (see FIG. 5) of the self-service POS terminal 1 acquires, via the communication unit 16, the advertisement information corresponding to a customer who is specified by the customer specifying unit 102 and registers the commodity by the self-service POS terminal 1 from a server device (not shown) connected to the self-service POS terminal 1 via a communication network or the like, the advertisement information acquisition unit 107 causes the screen display control unit 109 to display a current status screen 26 shown in FIG. 21 on the display device 81. The current status screen 26 is an example of the first display screen.

The current status screen 26 displays the advertisement display button BTj in addition to the information described in FIG. 6. The advertisement display button BTj is displayed in a vicinity of the detail display button BTa and is an icon indicating that advertisement information corresponding to the customer is present. The advertisement display button BTj also serves as an operation button, and by pressing the advertisement display button BTj, the customer can view the advertisement information (see FIG. 23). In order to reliably inform the customer that the advertisement display button BTj has been displayed, the screen display control unit 109 may cause the audio output unit 15 to output a sound or a sound effect indicating that the advertisement display button BTj is displayed. The advertisement display button BTj is an example of the second operation element.

If it is detected that the advertisement display button BTj is pressed on the current status screen 26, the screen display control unit 109 causes the display device 81 to display a registration detail screen 44 shown in FIG. 22. The registration detail screen 44 is an example of the second display screen.

The registration detail screen 44 displays the information described with reference to FIG. 8. That is, a detail list of the commodity information of all the commodities registered at the current time point is displayed from the bottom to the top in the registered commodity list 46 in the order of registration. The registration detail screen 44 further displays an advertisement display button BTk. The advertisement display button BTk is an icon indicating that advertisement information corresponding to the customer is present, and is an operation element for instructing the display of the advertisement information. When the operation receiving unit 101 detects that the advertisement display button BTk is pressed, the operation receiving unit 101 causes the screen display control unit 109 to display the advertisement display screen 45 on which the advertisement corresponding to the customer is displayed.

The advertisement display screen 45 displays advertisement information 68 in addition to the information displayed in the registered commodity list 46. In general, the advertisement information 68 is an advertisement for a commodity related to the customer in some manner. The advertisement information 68 can be acquired by the advertisement information acquisition unit 107 from a server device or the like connected to the self-service POS terminal 1 via a communication network or the like. The number of pieces of advertisement information 68 to be displayed is not limited to one. In the example of FIG. 23, three pieces of advertisement information 68 are displayed. The customer can scroll the advertisement information 68 and view the content of each advertisement by swiping an area in which the advertisement information 68 is displayed. The advertisement display screen 45 is an example of the second display screen.

Among the pieces of the advertisement information 68, a commodity purchase button BTl is displayed in the advertisement information displayed in the center. When the customer wants to purchase a commodity displayed in the advertisement information 68, the customer presses the commodity purchase button BTl. If the operation receiving unit 101 detects that the commodity purchase button BTl is pressed, the suspending control unit 108 temporarily suspends the registration operation. Then, the screen display control unit 109 causes the display device 81 to display a suspended screen 72 shown in FIG. 24.

Although the advertisement display screen 45 also displays the registered commodity list 46, the registered commodity list 46 displays only the commodity information registered most recently because the available display space is reduced by the display of the advertisement information 68.

In the suspended screen 72, as shown in FIG. 24, a header of the registration detail screen 44 displays a screen title indicating that the registration is being suspended. Typically, the self-service POS terminal 1 may be used by an unspecified number of customers, and a plurality of customers may each suspend the commodity registration processing. Therefore, the screen title desirably indicates the number of commodity registrations processing being suspended.

The suspended screen 72 displays a suspending release button BTm shown in FIG. 24. The suspending release button BTm is an operation element for instructing release of suspending of the commodity registration processing. If the operation receiving unit 101 detects that the suspending release button BTm is pressed, the operation receiving unit 101 causes the screen display control unit 109 to display a GUI for requesting an input of a one-time password on the display device 81. Then, the operation receiving unit 101 receives the input of the one-time password. If it is determined that a correct one-time password is input, the suspending control unit 108 cancels the suspended state of the commodity registration processing and causes the screen display control unit 109 to display the registration detail screen 44 (see FIG. 22) on the display device 81. At this time, the registration detail screen 44 may display a message such as “Suspended state is released. Please continue registration of a commodity.” for a predetermined time. When the commodity purchase button BTl is pressed, the suspending control unit 108 may cause the printing unit 7 to dispense a receipt on which an identification code for releasing the suspending is printed.

When the self-service POS terminal 1 is attached to a shopping cart used by a customer, that is, when the self-service POS terminal 1 constitutes a so-called cart POS, the cart POS is typically used only by the one customer who is currently controlling the cart POS up until the payment processing is ended, and thus the suspending control might not be required. When the self-service POS terminal 1 is used for a cart POS, the screen display control unit 109 may display a map indicating a display location of a commodity on the advertisement display screen 45 when the operation receiving unit 101 detects that the commodity purchase button BTl is pressed.

The advertisement information acquisition unit 107 of the self-service POS terminal 1 may promote advertisement information related to a commodity, for example, information based on statistical information indicating that there are many cases of purchasing another related commodity when purchasing a certain commodity, based on a content of the commodity registered by the customer without specifying the customer who registers the commodity in the self-service POS terminal 1.

### Flow of Advertisement Information Display Processing Performed by Self-Service POS Terminal

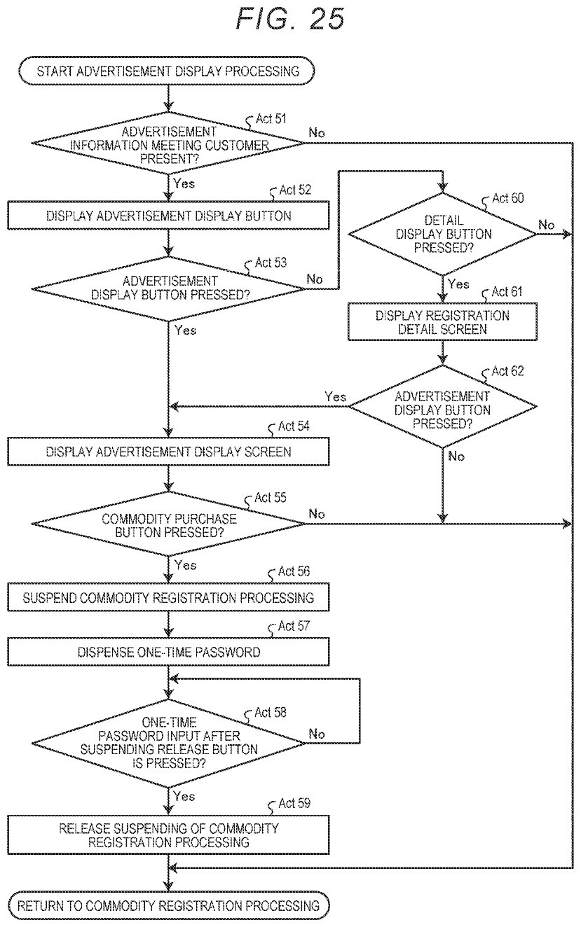

A flow of the advertisement information display processing performed by the self-service POS terminal 1 will be described with reference to FIG. 25. FIG. 25 is a flowchart showing an example of the advertisement information display processing performed by the self-service POS terminal 1. The flowchart of FIG. 25 is processing executed in parallel with the commodity registration processing during the execution of the flowchart representing the commodity registration processing shown in FIG. 10.

The advertisement information acquisition unit 107 determines whether advertisement information corresponding to the customer is present (Act 51). If it is determined that the advertisement information corresponding to the customer (e.g., based on demographic information, customer purchase history, or the like) is present (Act 51: Yes), the processing proceeds to Act 52. On the other hand, if it is determined that no advertisement information corresponding to the customer is present (Act 51: No), the self-service POS terminal 1 ends the processing in FIG. 25 and returns to the commodity registration processing in FIG. 10.

If it is determined in Act 51 that the advertisement information corresponding to the customer is present, the screen display control unit 109 causes the current status screen 26 to display the advertisement display button BTj (Act 52).

The operation receiving unit 101 determines whether the advertisement display button BTj is pressed on the current status screen 26 (Act 53). If the advertisement display button BTj is pressed (Act 53: Yes), the processing proceeds to Act 54. On the other hand, if the advertisement display button BTj is not pressed (Act 53: No), the processing proceeds to Act 60.

If it is determined in Act 53 that the advertisement display button BTj is pressed, the screen display control unit 109 next causes the display device 81 to display the advertisement display screen 45 (Act 54).

The operation receiving unit 101 determines whether the commodity purchase button BTl is pressed (Act 55). If the commodity purchase button BTl is pressed (Act 55: Yes), the processing proceeds to Act 56. On the other hand, if the commodity purchase button BTl is not pressed (Act 55: No), the self-service POS terminal 1 ends the processing in FIG. 25 and returns to the commodity registration processing in FIG. 10.

If it is determined in Act 55 that the commodity purchase button BTl is pressed, the suspending control unit 108 suspends the commodity registration processing, and then causes the screen display control unit 109 to display the suspended screen 72 on the display device 81 (Act 56).

The suspending control unit 108 dispenses a one-time password (Act 57).

The suspending control unit 108 also determines whether the one-time password is input after the suspending release button BTm is pressed (Act 58). If the one-time password is input after the suspending release button BTm is pressed (Act 58: Yes), the processing proceeds to Act 59. On the other hand, if the one-time password is not input after the suspending release button BTm is pressed (Act 58: No), Act 58 is repeated.

If it is determined in Act 58 that the one-time password is input after the suspending release button BTm is pressed, the suspending control unit 108 releases the suspending of the commodity registration processing (Act 59). Then, the screen display control unit 109 causes the display device 81 to display the registration detail screen 44. Thereafter, the self-service POS terminal 1 ends the processing in FIG. 25 and returns to the commodity registration processing in FIG. 10.

Returning to Act 53, if it is determined in Act 53 that the advertisement display button BTj is not pressed, the operation receiving unit 101 next determines whether the detail display button BTa is pressed (Act 60). If the detail display button BTa is pressed (Act 60: Yes), the processing proceeds to Act 61. On the other hand, if the detail display button BTa is not pressed (Act 60: No), the self-service POS terminal 1 ends the processing in FIG. 25 and returns to the commodity registration processing in FIG. 10.

If it is determined in Act 60 that the detail display button BTa is pressed, the screen display control unit 109 next causes the display device 81 to display the registration detail screen 44 (Act 61).

The operation receiving unit 101 determines whether the advertisement display button BTk is pressed on the registration detail screen 44 (Act 62). If the advertisement display button BTk is pressed (Act 62: Yes), the processing proceeds to Act 54. On the other hand, if the advertisement display button BTk is not pressed (Act 62: No), the self-service POS terminal 1 ends the processing in FIG. 25 and returns to the commodity registration processing in FIG. 10.

### Effects and Improvements of Embodiment

As described above, the self-service POS terminal 1 (a commodity information registration apparatus) of an embodiment includes the commodity code reading unit 103 (reading unit) that reads, from a commodity, the identification information of the commodity, the sales data processing unit 104 (registration unit) that registers the commodity corresponding to the identification information read by the commodity code reading unit 103, and the screen display control unit 109 (display control unit) that causes the display device 81 to display the current status screen 21 (first display screen) including the commodity information of the currently registered commodity, the information indicating the number of registered commodities and the total amount of money which are both smaller in size than the commodity information, and the detail display button BTa (first operation element) that displays the registration detail screen 41 (second display screen) including the detail list of the registered commodities. Accordingly, the interaction with the operator during the commodity registration can be performed more smoothly as compared to existing art systems. In particular, the customer can easily check the commodity information of a currently registered commodity, which is displayed larger than other information, and can view the detail list of the registered commodities at a timing at which the customer wants to view the detail list. Therefore, information desired to be viewed can be viewed in a timely manner.

In the self-service POS terminal 1 of an embodiment, the detail display button BTa (first operation element) is an icon imitating an accommodation body accommodating a commodity, and the screen display control unit 109 (display control unit) causes the commodity information displayed on the current status screen 21 (first display screen) to be displayed with a movement of being accommodated in the detail display button BTa when the sales data processing unit 104 (registration unit) registers the commodity. Accordingly, since the customer can understand a state in which the commodity desired to be purchased is reliably registered and accommodated in the accommodation body, the customer can obtain a sense of security.

In the self-service POS terminal 1 of an embodiment, when the sales data processing unit 104 (registration unit) registers the bulk discount target commodity, on condition that bulk discount condition has been satisfied, the screen display control unit 109 (display control unit) causes the current status screen 24 (first display screen) to display the commodity information related to a commodity as a bulk discount target and the commodity information related to a registered commodity as a bulk discount target in the same size side by side, and further display the bulk discount satisfied icon 54 (icon) indicating that the bulk discount condition has been satisfied. Accordingly, the customer can realize that the bulk discount condition has been satisfied.

In addition, in the self-service POS terminal 1 of an embodiment, the screen display control unit 109 (display control unit) causes the current status screens 25 and 26 (first display screen) to display the payment button BTb for instructing the execution of the payment, and the bag alert button BTg and the advertisement display button BTj (second operation element) for indicating the occurrence of an event related to the registration of a commodity and accessing the detailed information related to the event. Accordingly, when an unexpected situation or interrupt information occurs during the commodity registration processing, the screen can be immediately changed to the detailed screen, so that the detailed transaction content can be known.

The self-service POS terminal 1 of an embodiment further includes the customer specifying unit 102 that identifies a customer who uses the self-service POS terminal 1, and on the condition that the advertisement information 68 corresponding to the customer specified by the customer specifying unit 102 is acquired, the screen display control unit 109 (display control unit) causes the current status screen 26 (first display screen) to display the advertisement display button BTj (second operation element) indicating that advertisement information is present, and when the advertisement display button BTj is operated, the screen display control unit 109 causes the advertisement display screen 45 (second display screen) to display the advertisement information and the commodity purchase button BTl for instructing purchase of the commodity related to the advertisement information and suspending of the commodity registration operation. Accordingly, when a desired commodity is present in the advertisement information 68, the customer can suspend the commodity registration processing and return to shopping.

While certain embodiments have been described, the embodiments have been presented by way of example only, and are not intended to limit the scope of the inventions. The novel embodiment can be implemented in various other forms, and various omissions, replacements, and modifications can be made without departing from the gist of the invention. The embodiments and modifications thereof are included in the scope and gist of the invention described herein, and are also included in the invention described in the claims and equivalents thereof.

What is claimed is:

1. A commodity information registration apparatus, comprising:
a commodity reader configured to obtain commodity identification information for a commodity being registered in a sales transaction; and
a processor configured to:
register the commodity corresponding to the commodity identification information read by the commodity reader in the sales transaction, and
cause a display device to display a first display screen including commodity information of a registered commodity, an indicator of the total number of registered commodities in the sales transaction, and a total amount due indicator indicating the amount of money due in the sales transaction for the registered commodities, the first display screen further including a first operation element configured to cause a second display screen to be displayed when selected by a user, wherein
the commodity information of the registered commodity is displayed larger than the indicator of the total number of registered commodities and the total amount due indicator, and
the second display screen provides information including a detail list of the registered commodities.

2. The commodity information registration apparatus according to claim 1, wherein the first operation element is an icon depicting an accommodation body.

3. The commodity information registration apparatus according to claim 2, wherein the accommodation body is a shopping cart.

4. The commodity information registration apparatus according to claim 2, wherein the processor is further configured to:
cause the commodity information displayed on the first display screen to move into the depicted accommodation body when another commodity is subsequently registered in the sales transaction.

5. The commodity information registration apparatus according to claim 1, wherein the processor is further configured to:
cause the commodity information displayed on the first display screen to move into first operation element when another commodity is subsequently registered in the sales transaction.

6. The commodity information registration apparatus according to claim 1, wherein, when the commodity registered in the sales transaction is associated with a bulk discount condition and a second commodity registered in the sales transaction satisfies the bulk discount condition, the processor is configured to:
cause commodity information for the commodity and the second commodity to be displayed together side-by-side at the same size on the first display screen, and
display an icon on the first display screen indicating that the bulk discount condition has been satisfied.

7. The commodity information registration apparatus according to claim 1, wherein a payment operation element for requesting execution of payment processing for the sales transaction is displayed on the first display screen.

8. The commodity information registration apparatus according to claim 1, wherein a second operation element signaling an occurrence of an event related to the registration of the commodity is displayed when a display condition for the second operating element is met.

9. The commodity information registration apparatus according to claim 8, wherein the event is an advertisement information display condition is met by the registration of the commodity.

10. The commodity information registration apparatus according to claim 8, wherein
the processor is further configured to receive customer identification information, and
the event related to the registration of the commodity is the receiving of the customer identification information.

11. A point-of-sale apparatus, comprising:
a barcode reader configured to obtain commodity identification information for a commodity being registered in a sales transaction;
a display screen integrated with a touch panel for receiving user inputs; and
a processor configured to:
register the commodity corresponding to the commodity identification information read by the barcode reader in the sales transaction, and
cause the display screen to display a first screen including commodity information of a registered commodity, an indicator of the total number of registered commodities in the sales transaction, and a total amount due indicator indicating the amount of money due in the sales transaction for the registered commodities, the first screen further including a first operation element configured to cause a second screen to be displayed on the display screen when selected by the user, wherein
the commodity information of the registered commodity is displayed larger than the indicator of the total number of registered commodities and the total amount due indicator, and the second screen provides information including a detail list of the registered commodities.

12. The point-of-sale apparatus according to claim 11, wherein the first operation element is an icon depicting a shopping cart.

13. The point-of-sale apparatus according to claim 11, wherein the processor is further configured to:
cause the commodity information displayed on the first screen to move into first operation element when another commodity is subsequently registered in the sales transaction.

14. A commodity information registration method, comprising:
registering a commodity corresponding to commodity identification information read by a commodity reader in a sales transaction; and
causing a display device to display a first display screen including commodity information of a registered commodity, an indicator of the total number of registered commodities in the sales transaction, and a total amount due indicator indicating the amount of money due in the sales transaction for the registered commodities, the first display screen further including a first operation element configured to cause a second display screen to be displayed when selected by a user, wherein
the commodity information of the registered commodity is displayed larger than the indicator of the total number of registered commodities and the total amount due indicator, and
the second display screen provides information including a detail list of the registered commodities.

15. The commodity information registration method according to claim 14, wherein the first operation element is an icon depicting an accommodation body.

16. The commodity information registration method according to claim 15, wherein the accommodation body is a shopping cart.

17. The commodity information registration method according to claim 15, further comprising:
causing the commodity information displayed on the first display screen to move into the depicted accommodation body when another commodity is subsequently registered in the sales transaction.

18. The commodity information registration method according to claim 14, further comprising:
causing the commodity information displayed on the first display screen to move into first operation element when another commodity is subsequently registered in the sales transaction.

19. The commodity information registration method according to claim 14, further comprising:
when the commodity registered in the sales transaction is associated with a bulk discount condition and a second commodity registered in the sales transaction satisfies the bulk discount condition, causing commodity information for the commodity and the second commodity to be displayed together side-by-side at the same size on the first display screen, and displaying an icon on the first display screen indicating that the bulk discount condition has been satisfied.

20. The commodity information registration method according to claim 14, wherein
a payment operation element for requesting execution of payment processing for the sales transaction is displayed on the first display screen.

21. The commodity information registration method according to claim 14, wherein
a second operation element signaling an occurrence of an event related to the registration of the commodity is displayed when a display condition for the second operating element is met.
